(19) United States
(12) Patent Application Publication
(10) Pub. No.: US 2010/0273420 A1
(43) Pub. Date: Oct. 28, 2010

(54) DEVICE, SYSTEM, COMMUNICATION METHOD FOR DEVICE, AND COMMUNICATION METHOD FOR SYSTEM

(75) Inventor: Tooru MABUCHI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/715,708

(22) Filed: Mar. 2, 2010

(30) Foreign Application Priority Data
Apr. 24, 2009 (JP) P2009-106709

(51) Int. Cl. H04B 7/00

(52) U.S. Cl. 455/41.2

(57) ABSTRACT

A communication device includes a communication unit wirelessly communicating with another communication device in a connectable area; an acquiring unit acquiring a state of the communication device; a setting unit making a setting as to whether a connection is permitted to be established by the communication unit, on the basis of the state acquired by the acquiring unit; and a communication control unit responding to a connection request sent from the other communication device when connection with the other communication device is permitted by the setting unit.

### CROSS-REFERENCE TO RELATED APPLICATIONS

This application is based upon and claims the benefit of priority from the prior Japanese Patent Application No. 2003-342563 filed on Sep. 30, 2003; the entire contents of which are incorporated herein by reference.

### BACKGROUND OF THE INVENTION

1. Field of the Invention

The present invention relates to a communication device, a communication system, a communication method of a communication device, and a communication method of a communication system including short-range wireless communication capabilities and being capable of determining, on the basis of a state of the communication device, whether to respond a request for short-range wireless communication from another communication device.

2. Description of the Related Art

With widespread use of communication devices such as mobile phones in these years, more and more communication devices are equipped with short-range wireless communication capabilities such as Bluetooth (registered trademark) capabilities for directly communicating with other communication devices instead of through a base station. Devices such as headsets and keyboards capable of inputting and outputting audio and text data by wireless communication are also increasing. Systems have been built that enable communication between a communication device such as a mobile phone and such other devices equipped with communication capabilities.

For example, a portable radio communication device has been proposed that includes a plurality of communication units and is capable of maintaining or disconnecting connection with a mobile communication network appropriately (See Japanese Generated Patent Publication(Toroku), No. 3816475). The portable radio communication device comprises a first communication unit to perform radio communication with a base station of a mobile communication network, a second communication unit to perform radio communication with a handsfree device via a voice channel and a data channel, a mode switching unit to switch an operation mode between a first mode and a second mode, wherein the first mode enables a phone conversation using a microphone and a speaker of the portable radio communication device and the second mode enables the phone conversation using the handsfree device by transmitting voice data received from the base station through the first communication unit to the handsfree device through the second communication unit and by transmitting voice data received from the handsfree device through the second communication unit to the base station through the first communication unit.

When a communication device such as a mobile phone performs short-range wireless communication (for example Bluetooth communication) with another communication device, the communication device first sends a device inquiry to find any communication devices in a connectable area in order to establish a device connection, registers communication device(s) responding to the inquiry, and selects any of the registered communication devices to connect to. It is difficult for the user to identify a communication device to which the user wants to connect only by the name of the communication device acquired by the device inquiry in the sequence of the user operations. It is also difficult for the user to identify the user of a registered communication device although an address that uniquely identifies the communication device is displayed. There is another problem that a recipient possibly does not want to connect because the recipient is being occupied with another task or the communication device can be connected to an unintended communication device.

### SUMMARY OF THE INVENTION

The present invention has been made in view of above circumstances and provides a communication device that is capable of preventing an operation error that can occur when the communication device requesting a connection registers a communication device to connect to for short-range wireless communication and is also capable of preventing interruption of a task being performed on the communication device when the communication device acts as a responder (to be registered).

To address the problems described above, a communication device according to the present invention comprises: a communication unit configured to wirelessly communicate with another communication device in a connectable area; an acquiring unit configured to acquire a state of the communication device; a setting unit configured to make a setting as to whether a connection is permitted to be established by the communication unit, on the basis of the state acquired by the acquiring unit; and a communication control unit configured to respond to a connection request sent from the other communication device when connection with the other communication device is permitted by the setting made by the setting unit as to whether connection is permitted to be established.

And a communication system according to the present invention has a first communication device and a second communication device, wherein: the first communication device comprises a first communication unit configured to wirelessly request connecting each other to the second communication device if the second communication device is in a connectable area; and the second communication device comprises: a second communication unit configured to wirelessly communicate with the first communication device if the first communication device is in a connectable area; an acquiring unit configured to acquire a state of the second communication device; a setting unit configured to make a setting as to whether a connection is permitted to be established by the second communication unit, on the basis of the state acquired by the acquiring unit; and a communication control unit configured to respond to a connection request sent from the first communication device when connection with the other communication device is permitted by the setting made by the setting unit as to whether connection is permitted to be established.

And a communication method for a communication device according to the present invention comprises: a communication step for wirelessly communicating with another communication device in a connectable area; an acquiring step for acquiring a state of the communication device; a setting step making a setting as to whether a connection is permitted to be established at the communication step, on the basis of the state acquired at the acquiring step; and a communication control step for responding to a connection request sent from the other communication device when connection with the other communication device is permitted by the setting made at the setting step as to whether connection is permitted to be established.

And a communication method for a communication system according to the present has a first communication device and a second communication device, and comprises: a first communication step that the first communication device wirelessly requests connecting each other to the second communication device if the second communication device is in a connectable area; a second communication step that the second communication device wirelessly communicates with the first communication device if the first communication device is in a connectable area; an acquiring step that the second communication device acquires a state of the second communication device; a setting step that the second communication device makes a setting as to whether a connection is permitted to be established, on the basis of the state acquired at the acquiring step; and a communication control step that the second communication device responds to a connection request sent from the first communication device when connection with the other communication device is permitted by the setting made as to whether connection is permitted to be established at the setting step.

### BRIEF DESCRIPTION OF THE DRAWINGS

An Embodiment of the present invention will be described in detail based on the following figures, wherein:

FIG. 1 illustrates a system configuration of a communication system according to the present invention;

FIG. 2A is a front view of a communication device (mobile phone) according to the present invention in its open state;

FIG. 2B is a side view of the communication device (mobile phone) according to the present invention in its open state;

FIG. 3A is a front view of the communication device (mobile phone) according to the present invention in its closed state; FIG. 3B is a side view of the communication device (mobile phone) according to the present invention in its closed state;

FIG. 4 is a functional block diagram of a communication device (mobile phone) according to the present invention;

FIG. 5 is a schematic diagram illustrating a short-range wireless communication control process performed on a communication device (mobile phone) according to the present invention;

FIG. 6 is a flowchart of a procedure of a listening mode setting process performed on a communication device (mobile phone) according to the present invention;

FIG. 7 is a flowchart of a procedure of a short-range communication control process performed on a connection requesting communication device (mobile phone) according to the present invention; and

FIG. 8 is a flowchart of a procedure of a short-range communication control process performed on a responding communication device (mobile phone) according to the present invention.

### DETAILED DESCRIPTION OF THE PREFERRED EMBODIMENTS

Embodiments of a communication device according to the present invention will be described with reference to the accompanying drawings. As a communication device according to the present invention, an openable/closable clamshell mobile phone 1 including two or more housings coupled together so that one of the housing can swivel with respect to the other(s). The shape of the mobile phone 1 is not limited to the one including two or more housing coupled together so that one of the housing can swivel with respect to the other(s). The mobile phone 1 may be one including two or more housings slidably coupled together or one including other opening/closing mechanism, or one formed by a single housing without an opening/closing mechanism.

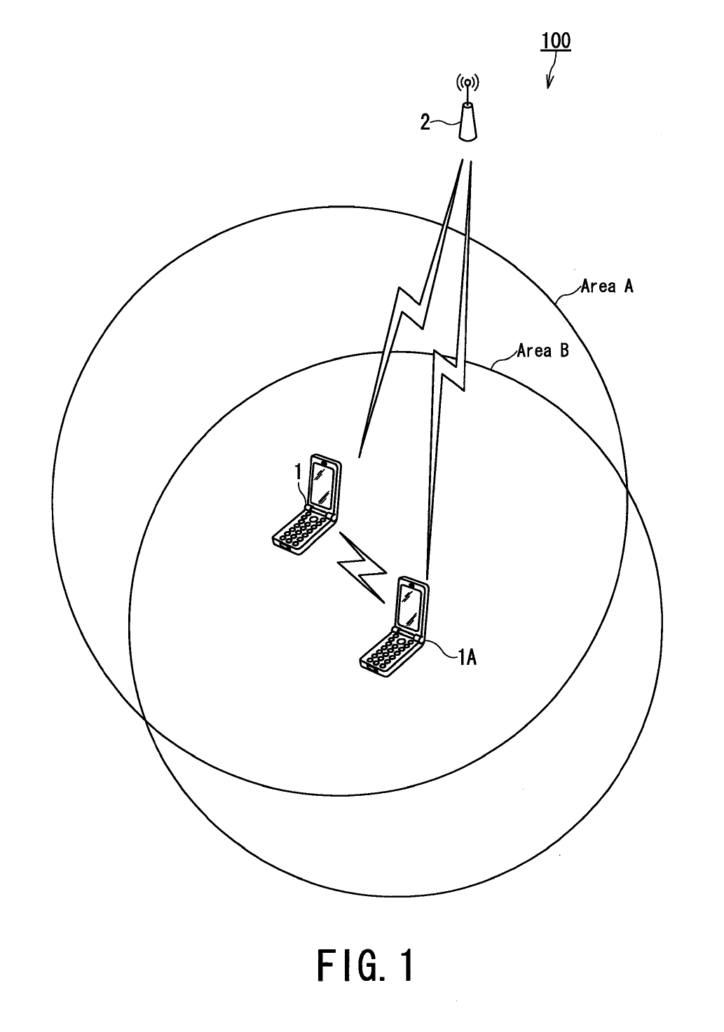

FIG. 1 illustrates a system configuration of a communication system 100 to which the mobile phone 1 is applied. As illustrated in FIG. 1, the communication system 100 includes communication terminals, for example mobile phones 1, 1A. The communication system 100 also includes a plurality of base stations 2. The mobile phones 1, 1A can communicate with each other by wirelessly connecting to the nearest one of the base stations 2.

Each of the mobile phones 1, 1A includes a short-range communication capability (for example Bluetooth (registered trademark) capability) to connect and communicate with a communication device in a short range (a predetermined range). For example, area A shown in FIG. 1 is the area in which the mobile phone 1 can communicate with another device by the short-range wireless communication capability and area B is the area in which the mobile phone 1A can communicate with another device by the short-range wireless communication capability. The mobile phone 1 can perform short-range wireless communication with the mobile phone 1A located in area A and the mobile phone 1A can perform short-range wireless communication with the mobile phone 1 located in area B.

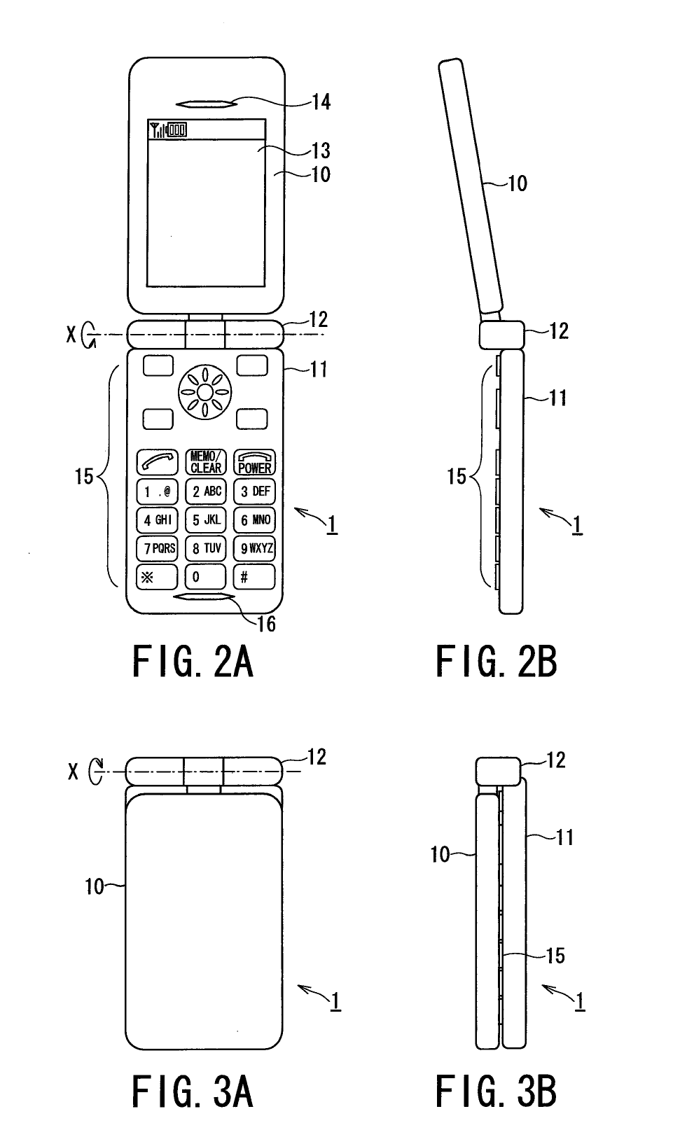

FIG. 2A is a front view of the mobile phone 1, 1A in its open state and FIG. 2B is a side view of the mobile phone 1, 1A in its open state. The mobile phone 1, 1A includes a rectangular plate-like upper housing 10 and a lower housing 11 similar to the upper housing 10 in shape, as shown in FIGS. 2A and 2B. In the closed state, the upper and lower housings 10 and 11 are stack on one another to cover one another. The upper and lower housings 10 and 11 are hinge-coupled with each other with a hinge unit 12 between them. The upper housing 10 is provided so that the upper housing 10 can swivel on the hinge unit 12 to a predetermined angle with respect to the lower housing 11 in the X direction illustrated in FIGS. 2A, 2B, 3A, and 3B. By swiveling the upper housing 10 with respect to the lower housing 11, the mobile phone 1, 1A is changed from the closed state to the open state and vice versa.

Provided on the inner surface of the upper housing 10 (the surface facing the lower housing 11) are a liquid-crystal display 13 for displaying a display screen containing information such as text and images and a speaker 14 for outputting sound. The liquid-crystal display 13 and the speaker 14 are not exposed but covered by the lower housing 11 when the mobile phone 1 is in the closed state. When the upper housing 10 is swiveled open with respect to the lower housing 11, the liquid-crystal display 13 and the speaker 14 are exposed.

Provided on the inner surface of the lower housing 11 (the surface facing the upper housing 10) are operation keys (keypad) 15 used by a user for inputting instructions. The operation keys 15 include an arrow keypad for moving a cursor and scrolling a display screen up, down, left and right, selection keys for selecting options, numeric keys for inputting numbers, a call initiation key for initiating a call, and other keys. A microphone 16 for collecting sound is also provided in the lower housing 11. The operation keys 15 and the microphone 16 are not exposed but covered by the upper housing 10 when the mobile phone 1, 1A is in the closed state. When the upper housing 10 is swiveled open with respect to the lower housing 11, the operation keys 15 and the microphone 16 are exposed.

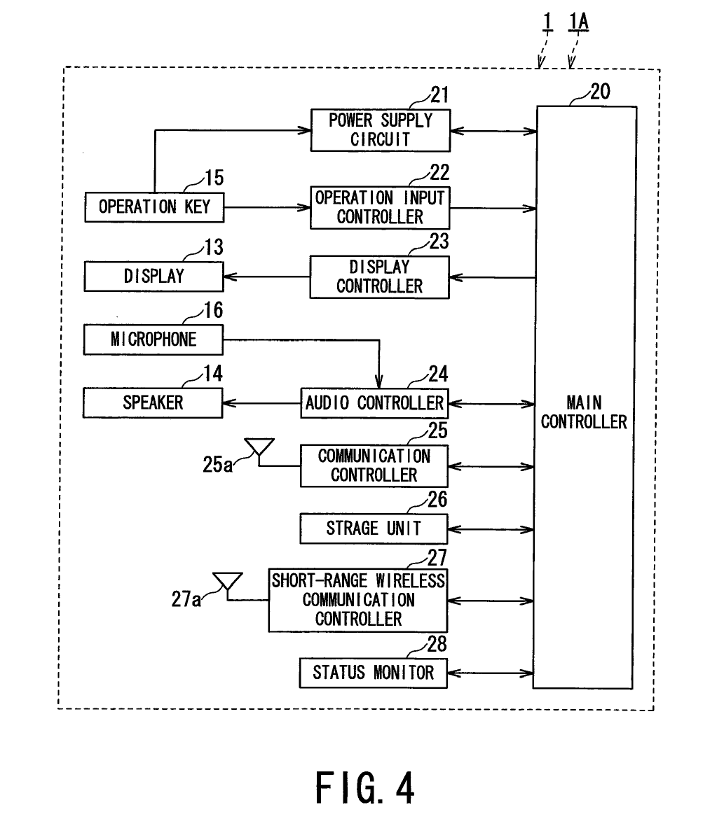

FIG. 4 is a block diagram illustrating functions of the mobile phone 1, 1A. The mobile phone 1, 1A includes a main controller 20, a power supply circuit 21, an operation input controller 22, a display controller 23, an audio controller 24, a communication controller 25, a storage unit 26, a short-range wireless communication controller 27, and a status monitor 28, which are communicably interconnected through a bus as shown in FIG. 4.

The main controller 20 includes a CPU (Central Processing Unit), centrally controls the mobile phone 1, 1A, and performs a communication control process, which will be described later, and various other computational processing and control processing. The power supply circuit 21 includes a power source such as a battery and turns on and off power supply according to an input through an appropriate operation key(s) 15 by the user. When the power supply is turned on, the power supply circuit 21 supplies power from the power source to the components of the mobile phone 1, 1A to activate the mobile phone 1, 1A.

The operation input controller 22 includes an input interface for the operation keys 15. When the operation input controller 22 detects a press of any of the operation keys 15, the operation input controller 22 generates a signal indicating the pressed key 15 and sends the signal to the main controller 20. When receiving the signal, the main controller 20 performs processing based on the signal. The display controller 23 includes a display interface for the display 13 and displays a screen containing text and images under the control of the main controller 20.

The audio controller 24, under the control of the main controller 20, generates an analog audio signal from sound collected through the microphone 16 and converts the analog audio signal to a digital audio signal. When the audio controller 24 acquires a digital audio signal, the audio controller 24, under the control of the main controller 20, converts the digital audio signal to an analog audio signal and outputs the analog audio signal as sound through the speaker 14.

The communication controller 25 includes an antenna 25a and applies spread-spectrum dispreading to a signal received from a base station (not shown) through the antenna 25a to reconstruct data under the control of the main controller 20. The data is provided to the audio controller 24, which outputs it through the speaker 14, or is provided to the display controller 23, which displays it on the display 13, or is stored in the storage unit 26, according to an instruction from the main controller 20. When the communication controller 25 acquires audio data collected through the microphone 16, data input through any of the operation keys 15, or data stored in the storage unit 26 under the control of the main controller 20, the communication controller 25 applies spectrum spreading to the data and transmits the resulting data to the base station through the antenna 25a.

The storage unit 26 includes storage such as a ROM (Read Only Memory), a hard disk, a non-volatile memory, a database which store process programs and data required for processing by the main controller 20, a RAM (Random Access Memory) which temporarily stores data used by the main controller 20 for processing. A process program executed by the main controller 20 when performing a communication control process, which will be described later, is stored in the ROM, for example.

The short-range wireless communication controller 27 includes an antenna 27a and provides wireless communication with another communication device through the antenna 27a. The short-range wireless communication controller 27 applies spread-spectrum dispreading to a signal received from another communication device through the antenna 27a to reconstruct data under the control of the main controller 20. The short-range wireless communication controller 27 applies spectrum spreading to data stored in the storage unit 26, for example, and transmits the resulting data to another communication device through the antenna 27a under the control of the main controller 20. The communication standard that the short-range wireless communication controller 27 uses may be Bluetooth (registered trademark) with a range of approximately 10 m, for example.

The short-range wireless communication controller 27, under the control of the main controller 20 turns on and off a device inquiry listening mode in which the mobile phone 1 listens for a device inquiry from another communication device. When the device inquiry listening mode is on, the short-range wireless communication controller 27 sends its own identification information in response to a device inquiry signal received from another communication device through the antenna 27a. When the device inquiry listening mode is off, the short-range wireless communication controller 27 does not respond to a device inquiry signal received from another communication device through the antenna 27a.

The status monitor 28 includes a plurality of Hall ICs and magnets provided in predetermined locations in the upper and lower housings 10 and 11. The Hall ICs detect magnetic fields of the magnets, thereby detecting whether the mobile phone 1 is in the closed state or open state. The Hall IC is a device in which a Hall element, which is a magnetic sensor, and a circuit that converts an output signal of the Hall element to a digital signal are packaged together and includes four terminals, namely, power supply terminal, a GND terminal, an S-pole detection output terminal, and N-pole detection output terminal.

When the mobile phone 1 is changed from the closed state to the open state, the status monitor 28 generates an opening detection signal and sends the signal to the main controller 20; when the mobile phone 1 starts changing from the open state to the closed state, the status monitor 28 generates a closing detection signal and sends it to the main controller 20.

Communication devices with which the mobile phone 1, 1A performs short-range wireless communication are a digital camera, a PDA (Personal Digital Assistants), digital television equipment, a printer, a PC (Personal Computer), a mobile phone, or any other devices, that all have the capability of performing wireless communication based on communication standards (such as Bluetooth) which is controlled by the short-range wireless communication controller 27.

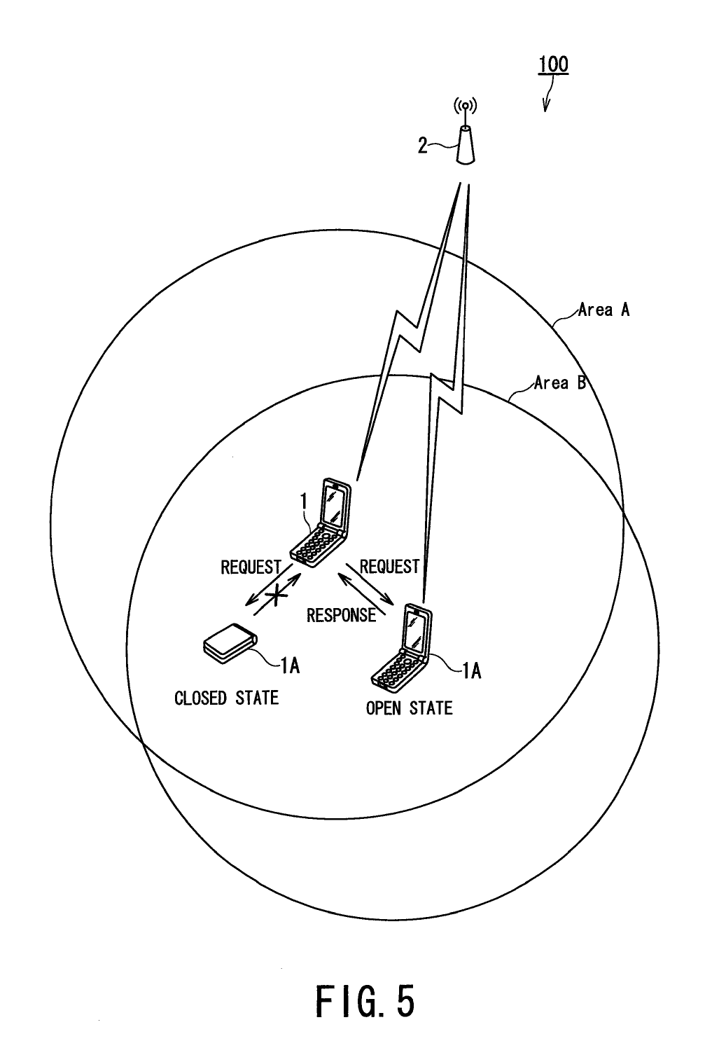

When the mobile phone 1, 1A performs short-range wireless communication, the short-range wireless communication controller 27 of the mobile phone 1, 1A sends identification information of the mobile phone 1, 1A to all other communication devices in a predetermined area (for example connectable area A that is a range of 10 m from the mobile phone 1, for example), as shown in FIG. 5. When the other communication devices receive the identification information of another communication device in their connectable areas (for example connectable area B that is a range of 10 m from mobile phone 1A), the communication devices return their identification information to the communication device that has sent the identification information. In this way, when any of the mobile phones 1, 1A and other communication devices performs short-range wireless communication, the device sends its identification information to all communication devices located in its connectable area, receives identification information returned from the communication devices located in the connectable areas and, based on the identification information, identify a communication device with which the communication device performs communication, then starts wireless communication.

When the mobile phones 1, 1A start wireless communication with another communication device, the communication requesting mobile phone 1, 1A sends its PIN (Personal Identification Number) code to the other communication device, which then authenticates the requesting device by using the PIN code. If authentication is successful, a connection is established between the requesting mobile phone 1, 1A and the requested communication device.

In some operating states of the mobile phone, 1, 1A, it may be undesirable to start short-range wireless communication in response to a request from a communication device. For example, the user of the mobile phone 1, 1A may be performing other operation, in a telephone conversation, or watching television on the mobile phone 1, 1A, or the user may be carrying the mobile phone 1, 1A in the closed state and possibly does not want to operate the mobile phone 1, 1A.

Therefore, it is desirable that for example when the user of the mobile phone 1A located in connectable area A of the mobile phone 1 as illustrated in FIG. 5 is holding the mobile phone 1A in the open state or is not performing any urgent action on the mobile phone 1A, the mobile phone 1A be connected to the mobile phone 1 in response to a short-range wireless communication request from the mobile phone 1 whereas when the user of the mobile phone 1A is keeping the mobile phone 1A closed or performing other operation on the mobile phone 1A, the mobile phone 1A be able to reject a short-rage communication request from the mobile phone 1.

When a short-range wireless communication connection is established between a plurality of communication devices in a certain range from each other and data is transmitted between them, a process is performed in which the communication devices that are to communicate with each other (for example the mobile phones 1 and 1A) identify themselves to each other and register each other as correspondent nodes. This communication process is defined as pairing in Bluetooth wireless communication. The conventional pairing procedure is performed on communication devices as follows. Once communication devices have turn on a Bluetooth radio, one of the communication device selects a communication device to communicate with among the communication devices a physical connection with which have been detected.

Therefore, it is desirable that a mechanism is provided that, when, for example, the user of the mobile phone 1 wants to perform short-range wireless communication with the mobile phone 1A in connectable area A but the user of the mobile phone 1A does not want to perform short-range wireless communication and keeps the mobile phone 1A closed, prevents registering the mobile phone 1A (communication device) in the identifying and registering process.

Each mobile phone 1, 1A has the capability of determining whether the user wants to establish a connection during the inquiry procedure for detecting a communication device to connect that is performed for registration. Based on the result of the determination, the mobile phone 1, 1A determines whether the mobile phone 1, 1A should respond to the inquiry. That is, the mobile phone 1, 1A is able to prevent an improper connection from another communication device by clearing the setting of a short-range wireless communication connection request listening mode depending on the state of the mobile phone 1, 1A. The capability does not affect a connection request from other communication devices that have been registered on the mobile phone 1, 1A but only prevent responding to the device inquiry.

Examples of conditions for a mobile phone 1, 1A to determine whether to respond a device inquiry are given below.

(A) Determine based on the operating state of the device
Open/closed state of the device (The device responds to a device inquiry when it is in the open state but does not when it is in the closed state.)
Keying state (The device responds to a device inquiry when the device is in a keying state but does not when it is not in the keying state.)
Keypad open/closed state (For an device whose keypad is opened and closed, the device responds to a device inquiry when the keypad is open and does not when the keypad is closed.)

(B) Determine based on whether the user is attempting to use short-range wireless communication
E-mail function use state (The device responds to a device inquiry when the e-mail function is active but does not when the e-mail function is inactive.)
Internet access function use state (The device responds to a device inquiry when the Internet access function is active but does not when the Internet function is inactive.)

(C) Determine based on whether the device is in the device inquiry listening mode
Device inquiry listening mode (The device responds to a device inquiry when it is in an inquiry listening mode but does not when it is not in the inquiry listening mode.)

The device inquiry listening mode may normally be on and, only when a predetermined condition is met, may be turned off. Alternatively, the device inquiry listening mode may normally be off and, when a predetermined condition is met, may be turned on. Alternatively, when a set of conditions are met, the device inquiry listening mode may be turned on and otherwise may be turned off.

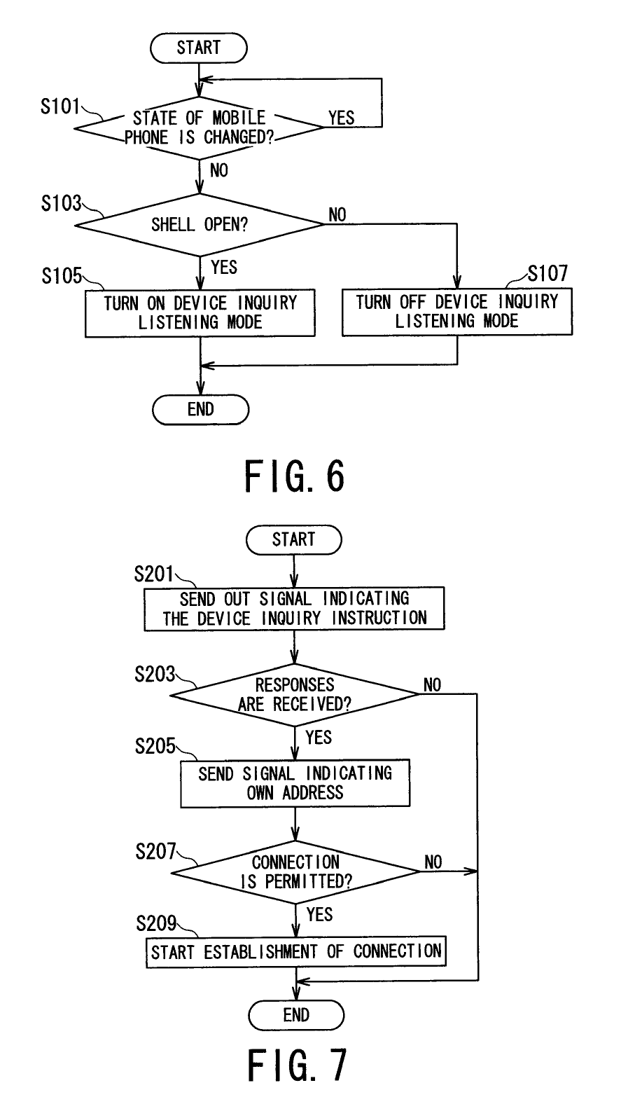

Every time the operating state changes, the mobile phone 1 first performs a listening mode setting process for setting whether to listen for a device inquiry for short-range wireless communication. A procedure of the listening mode setting process performed by the mobile phone 1 will be describe with reference to the flowchart of FIG. 6. In the example illustrated in FIG. 6, the mobile phone 1, 1A turns on and off a device inquiry listening mode depending on the operating state of the mobile phone 1, 1A, in particular, on the open/closed state of the mobile phone 1, 1A (Condition (A) described above). In the following description, “step” as in “step S101” will be sometimes abbreviated as “S” as in “S101”.

First, the main controller 20 determines whether the state of the mobile phone 1 has changed or not (S101). When the main controller 20 receives a signal from the status monitor 28 indicating that the position of the upper and lower housings 10 and 11 with respect to each other has changed, the main controller 20 determines that the state of the mobile phone 1 has changed. If the state has not changed (“No” at S101), the main controller 20 remains in the wait state.

When the state has changed (“Yes” at S101), the main controller 20 determines whether the mobile phone 1 has changed from the closed state to the open state (shell open) (S103). Here, the main controller 20 determines that the mobile phone 1 has changed to the open state when the signal received from the status monitor 28 is a shell open detection signal.

When the state of the mobile phone 1 has changed from the closed to open state (shell open) (“Yes” at S103), the main controller 20 turns on the device inquiry listening mode (S105). When the mobile phone 1 has changed from the open to closed state (shell closed) (“No” at S103), the main controller 20 turns off the device inquiry listening mode (S107).

In this way, the mobile phone 1 turns on and off the device inquiry listening mode for the short-range wireless communication capability when the state of the mobile phone has changed. Accordingly, the mobile phone 1 responds to a device inquiry from another communication device when the mobile phone 1 is in the open state but does not when the mobile phone is in the closed state.

If the condition for determining whether to respond to a device inquiry is the keying state, determination is made at step S101 as to whether has been started or ended and then determination is made at step S103 as to whether keying has been started or ended. When the keying has been started, the device inquiry listening mode is turned on at step S105. When the keying has been ended, the device inquiry listening mode is turned off at step S107.

If the condition for determining whether to respond to a device inquiry is the use (activation) state of the e-mail function or the Internet access function, determination is made at step S101 as to whether or not either the e-mail function or the Internet access function has been activated. At step S103, determination is made as to whether or not either the e-mail function or the Internet access function has been activated. When the e-mail function or the Internet access function has been activated, the device inquiry listening mode is turned on at step S105. If the e-mail function or the Internet access function has been deactivated, the device inquiry listening mode is turned off at step S107.

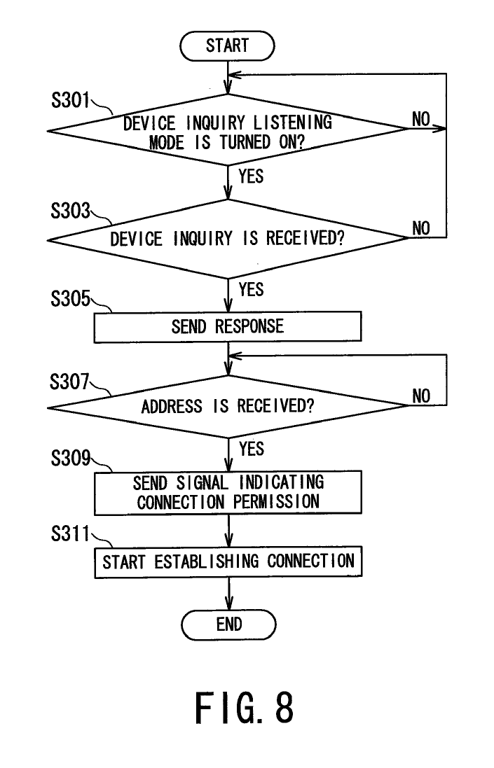

When the mobile phones 1, 1A subsequently perform short-range wireless communication with a communication device located in connectable area A, the mobile phone 1, 1A perform a communication control process for controlling the short-range wireless communication on the basis of whether the device inquiry listening mode has been turned on or off by the short-range wireless communication controller 27 (information stored at steps S101 through S107). Procedures of the communication control process performed by the mobile phones 1, 1A will be described with reference to the flowcharts of FIGS. 7 and 8. While it is assumed here that the mobile phone 1A is the sending end and the mobile phone 1 is the receiving end, the embodiment is not limited to this. The sending end may be the mobile phone 1 and the receiving end may be the mobile phone 1A or one of these devices may be other communication device.

A process at the sending end (for example the mobile phone 1A) will be described first with reference to the flowchart of FIG. 7. When the user wants to use the mobile phone 1A to communicate with another device by short-range wireless communication, the user presses appropriate keys 15 to instruct the mobile phone 1A to send a device inquiry to communication devices in a predetermined range from the mobile phone 1A. The main controller 20 receives the device inquiry instruction and sends out a signal indicating the device inquiry to the predetermined range from the mobile phone 1A (for example area B) (S201).

In response to the device inquiry, communication devices within area B send back their identification information identifying themselves. The main controller 20, after sending the device inquiry, determines whether the responses from any communication devices have been received at the mobile phone 1A (S203). If the short-range wireless communication controller 27 has received a response within a predetermined time period after the transmission of the device inquiry at step S201, the main controller 20 determines that the response has been received.

When a response has been received (“Yes” at S203), the main controller 20 sends a signal indicating the own address (the address of the mobile phone 1A) to the communication device that has sent the response (the mobile phone 1), on the basis of identification information of the responding communication device received (S205). When the responding communication device receives the address sent at step S205, the responding communication device sends a signal indicating permission to connect on the basis of the address, if the communication device connects to the requesting communication device.

The main controller 20 determines whether the connection is permitted by the communication device to which the address is sent at step S205 (S207). The main controller 20 determines that the connection is permitted on the basis of reception of the signal indicating permission to connect. If the connection is permitted (“Yes” at S207), establishment of a short-range wireless connection to the communication device is started (S209).

If responses have not been received from any of the communication devices (“No” at S203) or connection is permitted by none of the communication devices (“No” at S207), the main controller 20 will end the communication control process without starting short-range wireless communication.

In this way, when acting as the sending end in short-range wireless communication, the mobile phone 1, 1A sends a device inquiry to any other communication in a predetermined range (for example area A, B) and then starts short-range wireless communication with a communication device that has sent a connection permission in response to the device inquiry.

A process performed on the receiving end (for example the mobile phone 1) will be described with reference to the flowchart of FIG. 8. First, the main controller 20 determines whether the device inquiry listening mode has been turned on by the short-range wireless communication controller 27 (S301). If the device inquiry listening mode has not been turned on (“No” at S301), the main controller 20 waits until the device inquiry listening mode is turned on.

When the device inquiry listening mode has been turned on (“Yes” at S301), the main controller 20 determines whether a device inquiry has been received (S303). Here, the main controller 20 determines that a device inquiry has been received, on the basis of reception of information indicating a device inquiry sent from another communication device (for example the mobile phone 1A) at step S201. If a device inquiry has not been received (“No” at S303), the process returns to step S301, where the main controller 20 determines whether the device inquiry listening mode has been turned on.

When a device inquiry has been received (“Yes” at S303), the main controller 20 sends the own identification information as a response to the inquiry (S305). When the requesting communication device (for example the mobile phone 1A) receives the response to the inquiry, the requesting communication device sends back a signal indicating its address.

Therefore, the main controller 20 determines whether an address has been received from the requesting communication device within a predetermined time period after transmission of the response at S305 (S307). Here, the main controller 20 determines that an address has been received on the basis of reception of the address sent at step S205. If an address has not been received (“No” at S307), the main controller 20 waits until the address is received.

When the address has been received (“Yes” at S307), the main controller 20 sends a signal indicating a connection permission to the requesting communication device on the basis of the address (S309). The main controller 20 then starts establishing a connection with the requesting communication device (S311).

In this way, each of the mobile phones 1, 1A turns on and off the device inquiry listening mode when a change in state occurs that is determined on the basis of the device's operating state (such as open/closed states) or user operation state (such as a telephone conversation or Internet access). When a short-range wireless communication connection request is sent from another communication device, the mobile phone 1, 1A responds the inquiry and permits the connection when the device inquiry listening mode is in the on state but does not responds the request and rejects the connection request when the device inquiry listening mode is in the off state.

This mechanism prevents an operation error that can occur when a connection requesting device registers a communication device to which the device wants to connect by short-range wireless communication and also prevents interruption of a task being performed on the requested device when the device is requested to connect by short-range wireless communication. During registration of a device to connect to by short-range wireless communication, normally a PIN is exchanged in a connection response for security purposes. Operation for the PIN exchange can interrupt a task being executed. Because the mobile phone 1, 1A does not respond to a device inquiry depending on the state of the mobile phone 1, 1A, the possibility of interruption of a task being executed can be significantly reduced and an increase in power consumption that would otherwise be associated with sending back responses to device inquiries can be prevented.

A communication device (mobile phone 1) according to an embodiment of the invention is capable of preventing an operation error that can occur when the communication device attempts to register a communication device to connect to for performing a short-range wireless communication and is also capable of preventing interruption of a task being performed on the communication device to be registered.

While the present invention has been described with respect to mobile phones 1, the present invention is not limited to mobile phones. The present invention is applicable to any communication-capable terminals, such as PHS (Personal Handyphone System) terminals, PDAs (Personal Digital Assistants), portable music players, hand-held game machines, portable television equipment, or laptop PCs that include wireless communication capabilities.

What is claimed is:

1. A communication device, comprising:
a communication unit configured to wirelessly communicate with another communication device in a connectable area;
an acquiring unit configured to acquire a state of the communication device;
a setting unit configured to make a setting as to whether a connection is permitted to be established by the communication unit, on the basis of the state acquired by the acquiring unit; and
a communication control unit configured to respond to a connection request sent from the other communication device when connection with the other communication device is permitted by the setting made by the setting unit as to whether connection is permitted to be established.

2. The communication device according to claim 1, wherein:
the communication device changes its configuration state into at least two states, the acquiring unit acquires the configuration state; and
the setting unit permits the connection if the communication device is in first state and do not permit the connection if the communication device is in second state.

3. The communication device according to claim 1, wherein:
the acquiring unit acquires the performance state of a predetermined program on the communication device; and
the setting unit permits the connection if the predetermined program is performed and do not permit the connection if the predetermined program is not performed.

4. The communication device according to claim 3, wherein:
the acquiring unit acquires the performance state of a program of mail function on the communication device; and
the setting unit permits the connection if the program of mail function is performed and do not permit the connection if the program of mail function is not performed.

5. The communication device according to claim 3, wherein:
the acquiring unit acquires the performance state of a program of internet function on the communication device; and
the setting unit permits the connection if the program of internet function is performed and do not permit the connection if the program of internet function is not performed.

6. The communication device according to claim 3, wherein:
the acquiring unit acquires the key operating state on the communication device; and
the setting unit permits the connection if the keys of the communication device are operated and do not permit the connection if the keys of the communication device are not operated.

7. The communication device according to claim 1, wherein:
the communication device changes its configuration state into at least two states, a state in which keys are covered; and a state in which keys are not covered;
the acquiring unit acquires the state of keys; and
the setting unit permits the connection if the keys are not covered and do not permit the connection if the keys are covered.

8. A communication system having a first communication device and a second communication device, wherein:
the first communication device comprises a first communication unit configured to wirelessly request connecting each other to the second communication device if the second communication device is in a connectable area; and
the second communication device comprises:
a second communication unit configured to wirelessly communicate with the first communication device if the first communication device is in a connectable area;
an acquiring unit configured to acquire a state of the second communication device;
a setting unit configured to make a setting as to whether a connection is permitted to be established by the second communication unit, on the basis of the state acquired by the acquiring unit; and
a communication control unit configured to respond to a connection request sent from the first communication device when connection with the other communication device is permitted by the setting made by the setting unit as to whether connection is permitted to be established.

9. The communication system according to claim 8, wherein:
the acquiring unit of the second communication device acquires the configuration state of the second communication device; and
the setting unit of the second communication device permits the connection if the second communication device is in first state and do not permit the connection if the second communication device is in second state.

10. The communication system according to claim 8, wherein:
the acquiring unit of the second communication device acquires the performance state of a predetermined program on the second communication device; and
the setting unit of the second communication device permits the connection if the predetermined program is performed and do not permit the connection if the predetermined program is not performed.

11. A communication method for a communication device, comprising:
a communication step for wirelessly communicating with another communication device in a connectable area;
an acquiring step for acquiring a state of the communication device;
a setting step making a setting as to whether a connection is permitted to be established at the communication step, on the basis of the state acquired at the acquiring step; and
a communication control step for responding to a connection request sent from the other communication device when connection with the other communication device is permitted by the setting made at the setting step as to whether connection is permitted to be established.

12. The communication method for the communication device according to claim 11, wherein:
a configuration state is acquired at the acquiring step; and
the connection is permitted if the communication device is in first state and the connection is not permitted if the communication device is in second state at the setting step.

13. The communication method for the communication device according to claim 11, wherein:
a performance state of a predetermined program on the communication device is acquired at the acquiring step; and
the connection is permitted if the predetermined program is performed and the connection is not permitted if the predetermined program is not performed at the setting step.

14. The communication method for the communication device according to claim 13, wherein:
a performance state of a program of mail function on the communication device is acquired at the acquiring step; and
the connection is permitted if the program of mail function is performed and the connection is not permitted if the program of mail function is not performed at the setting step.

15. The communication method for the communication device according to claim 13, wherein:
the performance state of a program of internet function on the communication device is acquired at the acquiring step; and
the connection is permitted if the program of internet function is performed and the connection is not permitted if the program of internet function is not performed at setting step.

16. The communication method for the communication device according to claim 13, wherein:
the key operating state on the communication device is acquired at the acquiring step; and
the connection is permitted if the keys of the communication device are operated and the connection is not permitted if the keys of the communication device are not operated at the setting step.

17. The communication method for the communication device according to claim 11, wherein:
the state of keys is acquired at the acquiring step; and
the connection is permitted if the keys are not covered and the connection is not permitted if the keys are covered at the setting step.

18. A communication method for the communication system having a first communication device and a second communication device, comprising:
a first communication step that the first communication device wirelessly requests connecting each other to the second communication device if the second communication device is in a connectable area;
a second communication step that the second communication device wirelessly communicates with the first communication device if the first communication device is in a connectable area;
an acquiring step that the second communication device acquires a state of the second communication device;
a setting step that the second communication device makes a setting as to whether a connection is permitted to be established, on the basis of the state acquired at the acquiring step; and
a communication control step that the second communication device responds to a connection request sent from the first communication device when connection with the other communication device is permitted by the setting made as to whether connection is permitted to be established at the setting step.

19. The communication method for the communication system according to claim 18, wherein:
the second communication device acquires the configuration state of the second communication device at the acquiring step; and
the second communication device permits the connection if the second communication device is in first state and do not permit the connection if the second communication device is in second state at the setting step.

20. The communication method for the communication system according to claim 18, wherein:
the second communication device acquires the performance state of a predetermined program on the second communication device at the acquiring step; and
the second communication device permits the connection if the predetermined program is performed and do not permit the connection if the predetermined program is not performed at the setting step.
